(19) United States
(12) Patent Application Publication
(10) Pub. No.: US 2011/0145572 A1
(43) Pub. Date: Jun. 16, 2011

(54) Apparatus and method for protecting packet-switched networks from unauthorized traffic

(76) Inventors: Kenneth J. Christensen, Tampa, FL (US); Jeremy L. Rasmussen, Lutz, FL (US)

(21) Appl. No.: 12/653,560

(22) Filed: Dec. 15, 2009

(51) Int. Cl. H04L 9/00

(52) U.S. Cl. 713/160

(57) ABSTRACT

An apparatus and method for protecting packet-switched network links, intermediate nodes, and/or end nodes from unauthorized traffic identifies authorized traffic via a signature contained in each packet that is associated with a stored cryptographic key. Packets are forwarded (or passed through) only if they contain a signature having a pre-defined correlation to the associated key. Optionally, means for controlling the protection can be provided, so that unauthorized traffic is rejected when the protection is operative but is passed when it is not. Also optionally, intermediate degrees of protection such as prioritization of authorized traffic over unauthorized traffic can be provided.

### FIELD OF THE INVENTION

The present invention relates to packet-switched networks in general and, in particular, to an apparatus and method for protecting packet-switched network links, intermediate nodes, and/or end nodes from unauthorized traffic.

### SUMMARY OF THE INVENTION

An apparatus and method for protecting packet-switched network links, intermediate nodes, and/or end nodes from unauthorized traffic according to an embodiment of the present invention identifies authorized traffic (comprising packets) via a signature contained in each packet that is associated with a stored cryptographic key. Packets containing a signature having a pre-defined correlation (the correlation preferably involving a time-stamp or other non-replayable value) to an associated key are forwarded or passed through protected links/nodes, while those not containing such a signature are not (unless protection is disabled or not enabled).

In a further embodiment of the invention, a means for turning the protection off and on can be added, resulting in conditionally-protected packet-switched links and/or nodes that pass unauthorized traffic when protection is off, and reject unauthorized traffic when protection is on (e.g., when a denial-of-service attack or other threat is detected). In another further embodiment, intermediate degrees of protection can be provided, e.g., prioritization of authorized traffic over unauthorized traffic, etc.; those protections also may be controllable.

### BRIEF DESCRIPTION OF THE DRAWINGS

FIG. 1 is a diagram of a network employing an embodiment of an apparatus and method for protecting packet-switched networks from unauthorized traffic according to the present invention.

FIG. 2 is a block diagram of an apparatus, referred to herein as a ‘Passwall,’ for protecting packet-switched network links and/or nodes from unauthorized traffic according to the present invention.

FIG. 3 depicts a frame format of a signature-enabled packet according to an embodiment of the present invention.

FIG. 4 is a flowchart of the process of insertion of a signature into an outgoing packet (such as depicted in FIG. 3) by a sending end node.

FIG. 5 is a flowchart of the process of the packet signature-checking and forwarding decision by a Passwall.

FIG. 6 is a flowchart of the process of the packet signature-checking and transfer decision by a receiving end node.

### DETAILED DESCRIPTION OF EMBODIMENTS

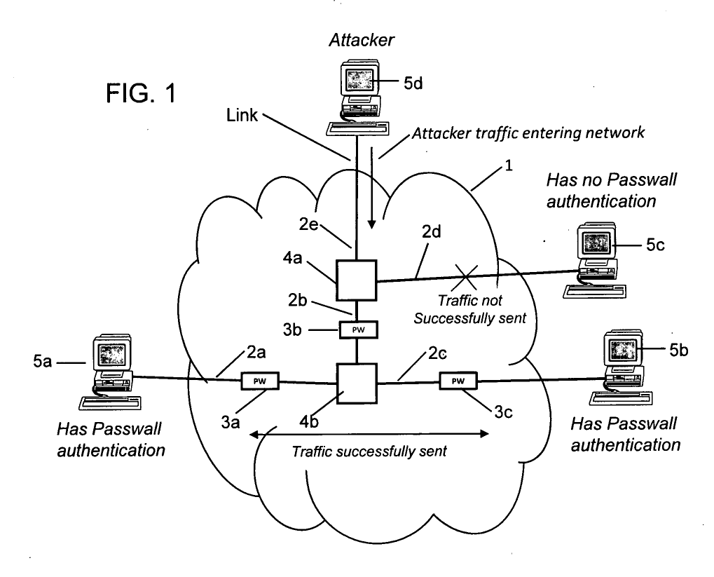

Referring to FIG. 1, a network 1 employing an embodiment of an apparatus and method for protecting packet-switched network links and nodes from unauthorized traffic according to the invention is shown. Some links (2a, 2b, and 2c) in the network 1 contain a Passwall (3a, 3b, and 3c) and other links and intermediate nodes do not (2d, 2e, 4a, and 4b). The Passwalls are shown as discrete entities, but alternately could be implemented within existing intermediate nodes. The intermediate nodes 4a and 4b may be routers or switches or any other apparatus that interconnects two or more network links and includes appropriate network protocols and transmission/reception means to communicate and appropriately forward packets between network links. Connected to the network are end nodes 5a, 5b, 5c, and 5d, which may be personal computers or any other apparatus that connects to the network and includes appropriate network protocols and transmission/reception means to communicate via the network. End nodes 5a and 5b contain the means for sending and receiving Passwall-authorized packets, while end nodes 5c and 5d do not. End node 5d is an attacker, e.g., sending packets into the network at a high rate with a goal of denying network services to other nodes by flooding links with attack traffic. End nodes 5a and 5b can communicate in the presence of the attack from end node 5d due to the existence of operating Passwall 3b on link 2b, whereas end node 5c may be incapacitated (that is, unable to send or receive packets to or from other end nodes) due to possibly overwhelming attacker traffic on link 2d entering the network on link 2e.

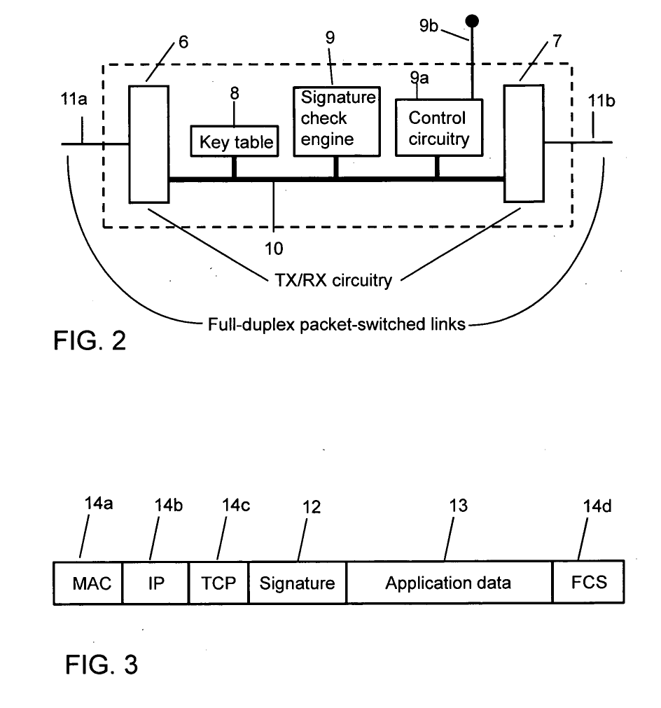

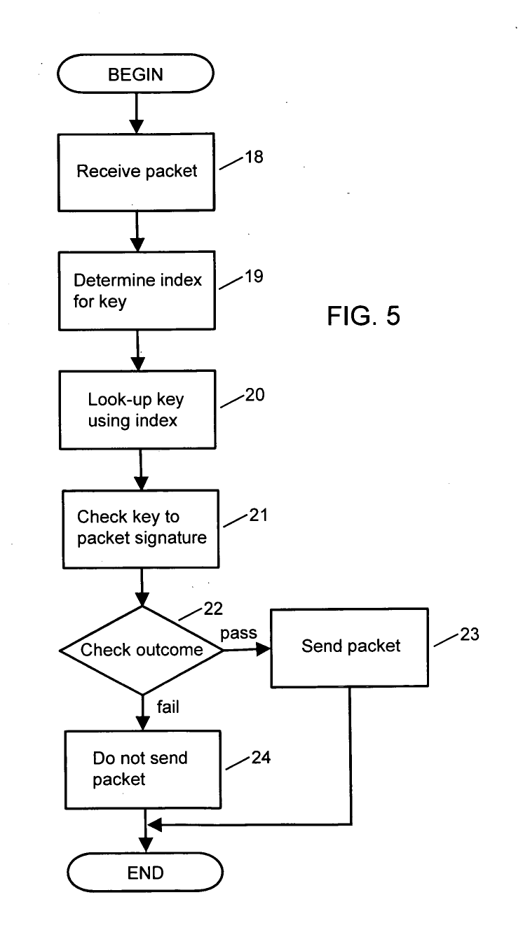

FIG. 2 shows the Passwall apparatus as it may be implemented in a standalone entity (e.g., spliced in-line) or within an existing intermediate node. As most links (e.g., 11a and 11b) are full-duplex (or bidirectional), the Passwall operates in both directions. As such, 6 and 7 contain the necessary circuitry to transmit and receive packets. The following describes operation with packets being received from 11a and transmitted on 11b, but operation in the opposite direction (i.e., receive on 11b and transmit on 11a) is equally possible. The Passwall includes receiver circuitry 6 that receives input via link 11a, transmitter circuitry 7 that sends output via link 11b, key table 8, and packet signature check engine 9, connected as shown by high-speed bus 10. (An embodiment of a Passwall could be based on a member of the Intel IXP family, which incorporate an AES co-processor cryptographic engine tightly coupled with a programmable tri-mode MAC device and have throughputs of multiple Gigabits per second). The Passwall is configured to perform a signature check on packets (see FIG. 5 and accompanying description below), and preferably does not alter packet contents or need to participate in network protocols beyond the raw receiving and transmission of packets, although optionally it may contain processing and storage means for logging packet statistics and facilitating forensic analysis, and/or means for performing other functions. Preferably, an embodiment of a Passwall includes means permitting it to be selectively be turned-on (to allow only authorized traffic to pass through) and turned-off (to allow all traffic to pass through) by 1) in-band control, 2) out-of-band control, and/or 3) automatically based on, for example, a measured high level of link utilization. In such an embodiment as shown, control circuitry 9a handles the turning on and off of the Passwall function, including the measurent of link utilization, as appropriate. (As shown, antenna 9b can be provided in conjunction with an optional out-of-band wireless capability can be provided). The control message for both in-band and out-of-band control could be an application-level packet.

FIG. 3 shows one possible format of a signature-enabled packet as might be embodied on a Local Area Network with sender and receiver applications using the TCP protocol for assured delivery of data, and with end nodes (and possibly intermediate nodes) using the IP protocol. In this example, the signature field 12 is an additional field, possibly found within the application data field 13, beyond existing LAN, IP, and TCP protocol fields 14a, 14b, 14c, and 14d (existing fields are MAC=Medium Access Control, IP=Internet Protocol, TCP=Transmission Control Protocol, and FCS=Frame Check Sequence), or possibly in the Options/Padding section of the TCP header. Alternately (not shown), the signature field could be superimposed, for example via a simple exclusive OR operation, on an existing field, such as the IP header checksum field (found within 14b for this example packet) for networks that use the IP protocol. Such an overloading of the checksum field would obviate the need to modify existing networking equipment to support the Passwall packet processing.

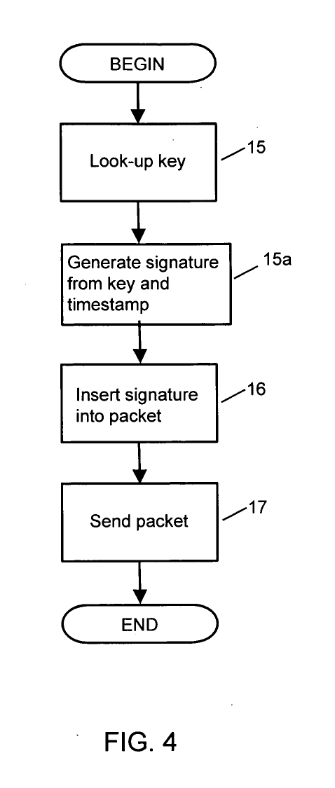

FIG. 4 shows a suitable process for including a signature in a packet transmitted from an application or protocol buffer in a sender end node to the network link, which process may be included as part of the embodiment of a network application or protocol implementation. The signature is based on a cryptographic key found in a key table, or other means of storing cryptographic keys, of the sender end node. At step 15 it is assumed that a packet is ready to be sent out on a network link, and a key is looked-up in the key table. In most senders there may only be one key. If there were a multitude of keys, a means of selecting the correct key must be included and can be based on any number of known methods to correlate a sender with its key. In step 15a the signature is generated as a function of the key and a timestamp (the current time, at a given granularity, e.g., whole seconds). A hash algorithm such as MD5 or SHA1 can be used to hash a string consisting of the timestamp and key concatenated (or some other combination of the timestamp, key, and/or packet's protocol fields and/or application data). Using a timestamp (or possibly another type of ‘number used once’) as an integral part of the signature minimizes the possibility of an attacker capturing authorized packets and using them as part of a so-called playback attack. At step 16 the signature is inserted in (or superimposed on) the packet to be sent, and finally in step 17 the packet is sent out on the network link, the packet now containing a signature.

FIG. 5 shows a suitable process for checking a packet received 18 by a Passwall for signature match to the associated key stored in the Passwall key table 8. The source of the received packet is identified 19, for example by the IP source address for networks that use the IP protocol, and is used to identify the appropriate key index for the key table 20 to use for the signature check 21 (in which step a test signature is generated by the Passwall based on its current time in the same manner as described above for step 15a performed by the sending end node). The signature check may be implemented in hardware circuitry as a masked exclusive OR operation where a pass decision would be an outcome of all 0s (Boolean false), but alternative implementations will be readily apparent. The outcome of the signature check (22) is pass or fail; if pass the packet is forwarded (23), or sent out (or passed through), on the network link and if fail the packet is not sent out (24). In some contexts, occasional false positives (or passes in 22) may be acceptable since greatly mitigating (though not completely eliminating) attack traffic still can allow adequate communication between authorized end nodes (i.e., adequate protection of network links and nodes). This acceptability of false positives may facilitate: a) the use of high-speed and low-cost probabilistic methods—such as Bloom filters—for signature matching, and/or b) the maintenance of keys for longer periods of time than normally prescribed to prevent an attacker from “cracking” the password.

Periodic key distribution and/or other suitable means can be employed to minimize the possibility of an attacker capturing authorized packets and replaying them in a packet flooding attack that would pass through a Passwall. Periodic generation and distribution (and possible revocation) of keys to intermediate and sender end nodes can be effected by various suitable known methods, such as:
1) The Internet Key Exchange (IKE or IKEv2), as defined in IETF RFCs 2407, 2408, 2409, 4301, and 4306-4309, which is used to establish Security Associations for IPSec, using a Diffie-Hellman key exchange to set up a shared session secret, from which cryptographic keys are derived. This scheme incorporates public key techniques or, alternatively, a pre-shared key, to authenticate communicating parties.
2) The Extensible Authentication Protocol (EAP), described in IETF RFCs 3748 and 5247, which specifies a key hierarchy and framework for transport and usage of keying material.
3) A custom key generation and distribution scheme that adheres to the best practices outlined in IETF RFC 4962: “Guidance for Authentication, Authorization, and Accounting (AAA) Key Management.”

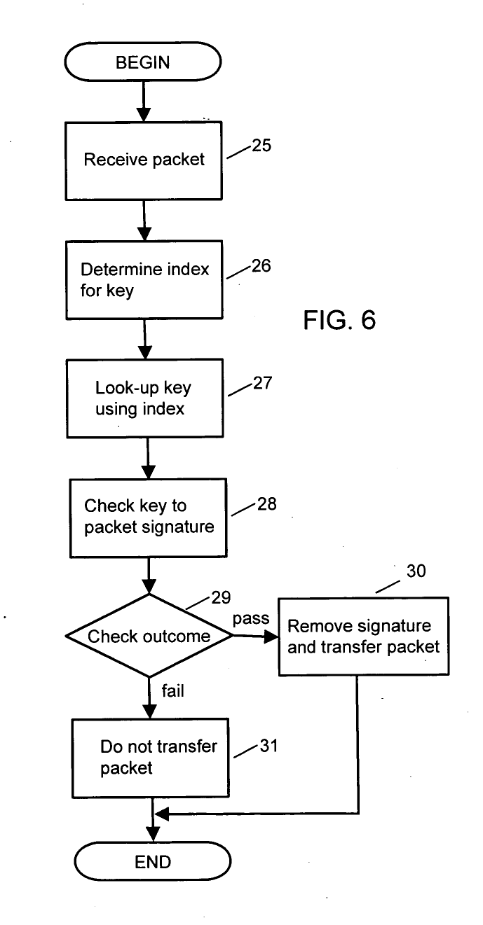

FIG. 6 shows a suitable process for checking a packet received by a receiving end node for signature match. The process typically, but not necessarily, is performed before the packet is transferred to an application in the receiver end node. At step 25 the packet is received and steps 26 to 29 are the same as steps 19 to 22 in FIG. 5 (but optionally implemented in part of a software program, and wherein in step 28 a test signature is generated by the receiving end node based on its current time in the same manner as described above for step 15a performed by the sending end node). In steps 30 and 31, the packet is transferred to the target application on pass, or not transferred on fail, respectively. In step 30 the signature may be removed before transferring the packet to the application. (Alternately, depending on the implementation of packet signature, an application could ignore signatures).

In a further embodiment of the invention, a means for turning Passwall protection on and off can be added, resulting in conditionally-protected packet-switched links or nodes that pass all traffic when the protection is off, and reject unauthorized traffic when the protection is on. For example, protection could be turned on under certain conditions only (e.g., when a packet-flooding denial-of-service attack or other threat is detected). The control of protection could be effected through an in- or out-of-band (e.g., wireless for out-of-band) control and management interface (wherein the channel used for key distribution could also be the control channel) and/or automatically based on traffic level (i.e., link utilization).

In another further embodiment, intermediate degrees of protection and/or other capabilities could be provided (instead of or as alternate settings to full or no protection), such as probabilistic signature-checking, prioritization of authorized traffic over unauthorized traffic, etc., and in such case means to trigger or disable those protections and/or other capabilities can be provided.

One skilled in the art will appreciate that other variations, modifications, and applications are also within the scope of the present invention. Thus, the foregoing detailed description is not intended to limit the invention in any way, which is limited only by the following claims and their legal equivalents.

What is claimed is:

1. An apparatus for protecting a packet-switched link, intermediate node, or intermediate node in a network from unauthorized traffic, wherein each packet of authorized traffic in the network contains a signature generated by a sender end node, said apparatus comprising:
a. an input;
b. a receiver connected to said input;
c. a transmitter;
d. an output connected to said transmitter;
e. memory containing one or more keys, wherein the signature in each packet of authorized traffic has a pre-defined correlation to a key in said memory; and
f. signature-checking circuitry connected to said memory, said receiver, and said transmitter.

2. The apparatus of claim 1, wherein said apparatus is embodied in a standalone hardware unit to protect a network link.

3. The apparatus of claim 1, wherein said apparatus is incorporated into an intermediate network node.

4. The apparatus of claim 1, wherein said signature-checking circuitry is configured to check the signature of packets received by said receiver for the presence or lack of said pre-defined correlation.

5. The apparatus of claim 1, wherein said signature-checking circuitry is configured to check the signature of each packet received by said receiver for the presence or lack of said pre-defined correlation.

6. The apparatus of claim 5, wherein said signature-checking circuitry is further configured to pass to said transmitter all packets containing signatures that have said pre-defined correlation, and to discard packets that do not have said pre-defined correlation.

7. The apparatus of claim 6, wherein said pre-defined correlation of the signature in a packet of authorized traffic to a key in said memory is a function of the time of transmission of that packet.

8. The apparatus of claim 7, wherein said pre-defined correlation of the signature in a packet of authorized traffic to a key in said memory is also a function of at least part of that packet's other contents.

9. The apparatus of claim 7, wherein said pre-defined correlation is based on a hashing algorithm.

10. The apparatus of claim 1, wherein said apparatus can be set to a protected state in which said signature-checking circuitry is configured to check the signature of each packet received by said receiver for the presence or lack of said pre-defined correlation and to pass to said transmitter all packets containing signatures that have said pre-defined correlation and to discard packets that do not have said pre-defined correlation, or to an unprotected state in which said signature-checking circuitry is configured to pass all packets to said transmitter irrespective of whether or not they contain a signature having said pre-defined correlation.

11. The apparatus of claim 10, wherein said pre-defined correlation of the signature in a packet of authorized traffic to a key in said memory is a function of the time of transmission of that packet.

12. A method of protecting a packet-switched link or intermediate node in a network from unauthorized traffic, comprising the following steps:
a. providing one or more authorized sender end nodes in the network with one or more respective keys;
b. providing one or more protection devices each connected to a packet-switched link or incorporated into an intermediate node in the network, and each including a memory containing sender end node keys, and each being adapted to have protection turned off and on;
c. causing said one or more authorized sender end nodes to include in each outgoing packet a signature having a pre-defined correlation to the respective sender end node's key; and
d. when protection of said one or more protection devices is turn on, causing said one or more protection devices to pass packets that include signatures having said pre-defined correlation and to reject packets that do not include signatures having said pre-defined correlation.

13. The method of claim 12, wherein said pre-defined correlation of a packet's signature to the respective sender end node's key is a function of the time of transmission of that packet.

14. The method of claim 13, wherein said pre-defined correlation of a packet's signature to the respective sender end node's key is also a function of at least part of that packet's other contents.

15. The method of claim 13, wherein said pre-defined correlation is based on a hashing algorithm.

16. The method of claim 12, wherein protection is turned on when a denial of service attack is detected.

17. The method of claim 16, wherein protection is turned off when no denial of service attack is detected.

18. The method of claim 12, wherein protection is turned off and on automatically.

19. The method of claim 12, wherein said one or more protection devices are each embodied in a standalone hardware unit.

20. The method of claim 12, wherein said one or more protection devices are each incorporated into an intermediate network node.
